(19) United States
(12) Patent Application Publication
(10) Pub. No.: US 2004/0019653 A1
(43) Pub. Date: Jan. 29, 2004

(54) Context-aware client system

(76) Inventors: Philippe Debaty, Mountain View, CA (US); Thomas P. Duebendorfer, Zurich (CH)

Correspondence Address: HEWLETT-PACKARD COMPANY, Intellectual Property Administration, P.O. Box 272400, Fort Collins, CO, 80527-2400, US

(21) Appl. No.: 10/206,726

(22) Filed: Jul. 26, 2002

(51) Int. Cl. G06F 15/16

(52) U.S. Cl. 709/217

(57) ABSTRACT

A context-aware client system includes a web browser that sends a request to a remote web server to retrieve a web page from the remote web server. A context store stores context information of the client system. A transformation module is coupled to the web browser and the context store to add the context information into the web page before the web page is displayed by the web browser such that services specified in the context information and available to the client system can be readily invoked via the modified web page. A method of including context information of a client system into a web page shown by the client system is also described.

### BACKGROUND OF THE INVENTION

1. Field of the Invention

The present invention pertains to the Internet. More particularly, this invention relates to a client system that adds context information of the client system into web pages to be shown on the client system such that services specified in the context information and available to the client system can be readily invoked via the modified web pages.

2. Description of the Related Art

At minimum, a World Wide Web (“WWW”) network system typically includes a client system connected to a web server via a gateway system. The web server hosts or contains web pages that can be retrieved by the remote client system using a web browser software. The communication between the web server and the client system follows the client-server model and relies on the Transmission Control Protocol (TCP) for reliable delivery of information. The communication protocol between the client system and the web server can be the HTTP (Hyper Text Transfer Protocol) protocol, which is an open standard protocol.

The client system can also be referred to as a client device or an access device. The client system can be implemented by a computer system, a PDA (Personal Digital Assistant), or other electronic device with data processing capabilities (e.g., a cell phone or a web TV). This means that the client system can be stationary or mobile. But no matter where it is, a client system is always within its own environment (i.e., personalized environment) which can be defined by the Internet-enabled entities or devices located adjacent to the client system. The entities or devices provide services via the Internet. For example, if the client system is located in an office near an Internet-enabled printer, the personalized environment of the client system may be defined just by the printer. As a further example, when the client system is in a conference room, the personalized environment may be defined by an Internet-enabled projector, an Internet-enabled printer, an Internet-enabled light control, an Internet-enabled room temperature control, and an Internet-enabled speaker, all of which are in the conference room.

The personalized environment of a client system changes when the client system moves to a new location. For example, if the client system is in a family room of a home, its personalized environment may include a TV, a stereo system, a DVD player, a printer, a digital camera, a light control, and a temperature control, each of which is Internet-enabled and in the family room. But when the client system moves to a bedroom of the same home, then the personalized environment of the client system may be changed to only include an Internet-enabled light control in the bedroom. This means that the personalized environment is location-dependent. In other words, a client system may have more than one personalized environment.

The information describing a personalized environment is referred to as the context information. The context information of a personalized environment specifies or describes all Internet-enabled services within the environment. As described above, the Internet-enabled services can be provided by the physical entities/devices adjacent to the client system. These services can therefore be referred to as context-aware services or local services. In addition, the context information may also include location information of the client system, identity information of the client system, and sensor readings information from the environment, etc.

Prior art schemes have been proposed to invoke the context-aware services using the context information. One such prior art scheme is to provide context-aware web sites that store the context information of each client system. In this case, the user first has to log onto the context-aware web sites to get the context information delivered. Such sites, however, are extremely costly and the user is restricted to only a few web sites that have been modified to contain the context information. In other words, the context information is not automatically provided to the user. Moreover, the user must have a different account at each of such sites and most web sites cannot use the user's location information to retrieve the associated context information.

In addition, today's web browsers (e.g., the Internet Explorer® from Microsoft Corporation of Redmond, Washington or the Netscape® from AOL Time Warner Corporation of New York, N.Y.) provide only a bare means for the user to integrate additional features. Depending on the MIME-type of a downloaded file, the web browser can launch an external application or a plug-in to handle that content. For each new feature, the new service has to be installed locally and the web browser has to be reconfigured.

### SUMMARY OF THE INVENTION

One feature of the present invention is to add context information of a client system into web pages shown on the client system.

Another feature of the present invention is to add context information of a client system into web pages shown on the client system such that services specified in the context information and available to the client system can be readily invoked via the modified web pages.

In accordance with one embodiment of the present invention, a context-aware client system includes a web browser that sends a request to a remote web server to retrieve a web page from the remote web server. A context store in the client system stores context information of the client system. A transformation module is coupled to the web browser and the context store to add the context information into the web page before the web page is rendered by the web browser such that services specified in the context information and available to the client system can be readily invoked via the modified web page.

A method of including context information of a client system into a web page to be rendered on the client system includes the step of storing the context information in a context store. A request is processed to retrieve the web page from a remote web server. The context information is then added into the web page before the modified web page is rendered on the client system such that services specified by the context information and available to the client system can be readily invoked via the modified web page.

### BRIEF DESCRIPTION OF THE DRAWINGS

FIG. 1 shows a network system that includes a context-aware client system that implements one embodiment of the present invention.

FIG. 2 shows the structure of the context-aware client system of FIG. 1 that includes a web browser, a context information store, and a transformation module.

FIG. 3 is a flowchart diagram showing the operational process of the transformation module of FIG. 2.

FIG. 4 schematically illustrates an example of a modified web page by the context-aware client system of FIGS. 1-3.

### DETAILED DESCRIPTION OF THE INVENTION

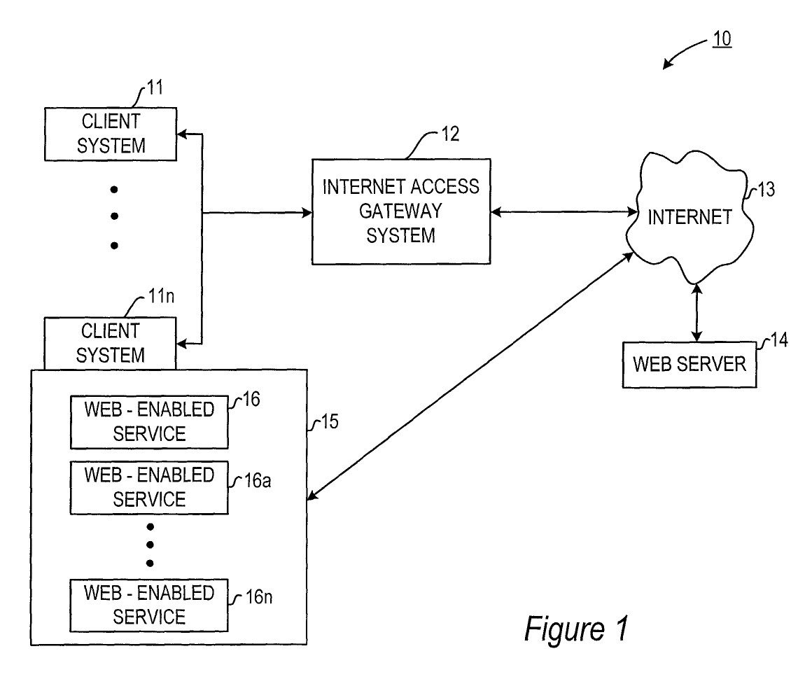

FIG. 1 shows a network system 10 that includes a number of client systems 11-11n, at least one of which (i.e., the client system 11n) is a context-aware client system that implements one embodiment of the present invention. In one embodiment, the network system 10 is a World Wide Web (“WWW”) network system. Alternatively, the network system 10 can be other type of data service network system.

As will be described in more detail below, the client system 11n is a context-aware client system that seamlessly embeds context information defining a personalized environment 15 of the client system 11n into arbitrary web pages to be rendered on the client system 11n such that users of the client system 11n can invoke web-enabled services (i.e., the services 16-16n) within the personalized environment 15. The context information can be in the form of a single URL (Universal Resource Locator) hyperlink or a context menu having a number of command-like URLs. Such a URL could reference an Internet-enabled device or service within the environment, and hold encoded parameters.

This embedding process is transparent to the users at the client system 11n, and requires no change to either the web browser at the client system 11n, or the web server 14 that stores the unmodified web pages. This means that a user at the requesting client system 11n can get personalized (i.e., context-aware) content from any web server. Additionally, the user's context information is not disclosed to any web server from which the user retrieves a web page.

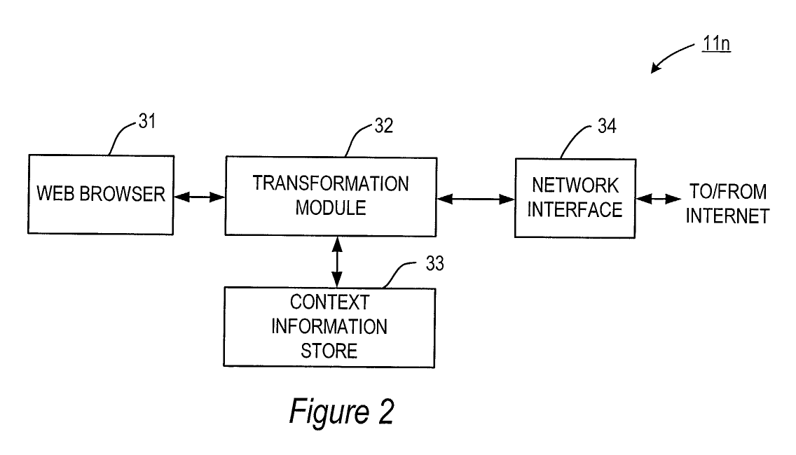

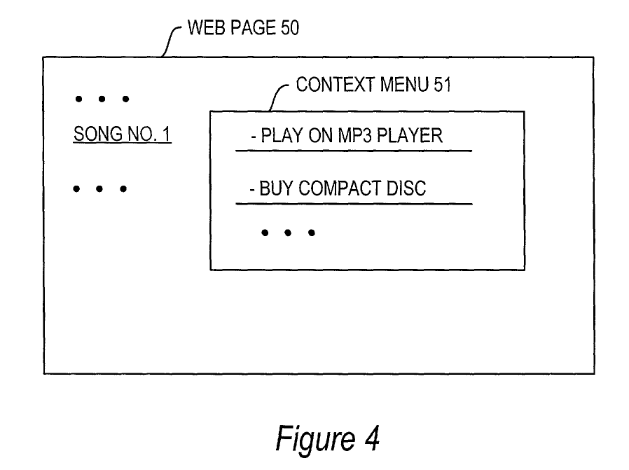

To achieve this, the context-aware client system 11n includes a context store 33 (see FIG. 2) that stores the context information that defines the personalized environment 15 of the client system 11n. The web browser 31 (see FIG. 2) of the client system 11n sends a request to the remote web server 14 to retrieve a requested web page from the remote web server 14 via the network interface 34 (see FIG. 2). In addition, a transformation module 32 (see FIG. 2) is connected between the context store 33, the network interface 34, and the web browser 31 to (1) retrieve the context information of the client system 1 In from the context store 33 and (2) add or include the context information into the web page that has been requested by the web browser 31 and retrieved in the network interface 34 before the web page is sent to the web browser 31 for rendering. The context information is added into the web page in the form of, for example, a single URL or a context menu (e.g., the context menu 51 in FIG. 4) that includes a number of command-like URLs. The structure and operation of the context-aware client system 11n will be described in more detail below, also in conjunction with FIGS. 1-4.

Referring again to FIG. 1, the context-aware client system 11n is connected to the remote web server 14 via an Internet access gateway system 12 and the Internet 13. The Internet 13 is, in fact, formed by multiple servers (including web servers) connected together via communication networks.

FIG. 1 only shows one web server 14. This is for illustration purpose only. In practice, the context-aware client system 11n can access multiple web servers via the Internet 13. The web server 14 can be implemented using known technology and stores web pages that can be retrieved to any one of the client systems 11-11n upon request. The web server 14 may also be connected to application servers (not shown in FIG. 1) that provide services to the client systems 11-11n via the web server 14.

Each of the client systems 11-11n can be a computer system or other electronic device with a web browser software (not shown). If a client system is a computer system, it can be a PDA (Personal Digital Assistant), a notebook computer, a mini-computer, a desktop computer, a workstation computer, a super computer, or a server computer. If a client system is implemented by an electronic device, the electronic device can be a cellular phone, a pager, a watch, or a digital camera.

The browser software in each of the client systems 11-11n sends access requests to and receive responses from the remote web server 14 via the Internet access gateway system 12. This allows its user (i.e., a person) to access the contents hosted in the remote web server 14.

The communication among various systems within the network system 10 is conducted using a predetermined open-standard communication protocol for Internet communications. In one embodiment, the protocol is the HTTP protocol.

The gateway 12 functions as a gateway to the Internet 13 and the web server 14 for the client systems 11-11n. The gateway system 12 receives requests from the client systems 11-11n. The gateway system 12 also contacts the remote web server 14 to retrieve the requested web pages based on the requests it received from the client systems 11-11n. In addition, the gateway 12 may include a proxy server (not shown) that temporarily caches web pages that have been retrieved from the web server 14. When a cached web page is again requested either by the same client system or by another client system, the proxy server allows the cached web page to be quickly retrieved and sent to the requesting client system. The gateway system 12 is also used as a firewall to shield the client systems 11-11n from unauthorized external accesses via the Internet 13 (i.e., for security purposes).

As can be seen from FIG. 1, the client system 11n includes at least one personalized environment. FIG. 1 only shows one such environment 15 for the client system 11n for illustration purpose.

The personalized environment 15 is defined to include a number of web-enabled services 16-16n. Some of these services 16-16n can be provide by web-enabled physical means adjacent to the client system 11n. Some of the services 16-16n can also be provided by mechanism not adjacent to the client system 11n. For example, if the client system 11n is located in an office near an Internet-enabled printer, one of the web-enabled services 16-16n may be provided by the Internet-enabled printer while another one of the web-enabled services 16-16n is provided by a remote e-commerce service (e.g., on-line ordering or banking) server. As a further example, if the client system 11n is in a conference room, some of the web-enabled services 16-16n of the personalized environment 15 may be provided by an Internet-enabled projector, an Internet-enabled printer, an Internet-enabled light control, an Internet-enabled room temperature control, and an Internet-enabled speaker, all of which are in the conference room.

The personalized environment 15 changes when its associated client system 11n moves to a new location. In other words, the client system 11n may have more than one personalized environment. For example, if the client system 11n is in a family room of a home, some of the web-enabled services 16-16n of the personalized environment 15 may be provided by a TV, a stereo system, a DVD player, a printer, a digital camera, a light control, and a temperature control, each of which is Internet-enabled. But when the client system 11n moves to a bedroom of the same home, then the personalized environment 15 may be changed to only include an Internet-enabled light control in the bedroom.

The information describing a personalized environment is referred to as the context information. The context information of a personalized environment specifies or describes all Internet-enabled services within the environment. In addition, the context information may also include location information of the client system, identity information of the client system, and sensor readings information from the environment, etc. The context information can be in the form of a single URL hyperlink or a context menu of a number of command-like URLs. Such a URL could reference an Internet-enabled device or service within the environment, and hold encoded parameters. Moreover, the context information may specify preferences of the user of the client system.

There are many ways to define or discover the personalized environment 15. One way is to have all the services wanting to be included in the personalized environment 15 associate or register its service in the client system 11n (i.e., passive discovery). Another way is to have the client system 11n discover the services 16-16n of the personalized environment 15.

The context information of each personalized environment for the client system 11n is then stored in the client system 11n, thus allowing the client system 11n to become the context-aware client system. In accordance with one embodiment of the present invention, the client system 11n seamlessly embeds the context information into arbitrary web pages to be rendered on the client system 11n.

In other words, using the client-specific context information and the content of a retrieved web page, the client system 11n adds or includes command-like URLs at appropriate places or locations within the web page. Each location within the web page may be added with one command-like URL or a context menu having a number of command-like URLs. For example, when the web page contains a hyperlink of a MP3 file of a song, the client system 11n can place, next to the hyperlink of the file, a URL of a local web-enabled MP3 player with a user interface that allows the user to input the user preferred playing parameters (e.g., volume). When the user clicks the URL of the MP3 player, the song can be played at the user's preferred loudness on the local web-enabled MP3 player. In addition, the URL can be replaced with a context menu of a number command-like URLs. For example, the context menu may reference a web-enabled music playing service provided by a MP3 player, a web-enabled on-line ordering service (provided by a remote e-commerce server) to allow the user to order a CD that contains the song, or to order to the MP3 file of the song. Each command-like URL is a location-aware, and URL-dependent command. Some of the command-like URLs can also depend on MIME-type. This means that the MIME-type of a document linked by a hyperlink in a web page can be retrieved and used to determine what local device or service can process this document. For example, an MP3 file (of MIME-type audio/MPEG) can be processed by a local MP3 player but not by a local printer.

This dramatically enhances the capabilities of the web browser of the client system 11n that finally receives the modified web page because the user can now simply click on the added URLs to invoke the respective context-aware services (e.g., the services 16-16n) within their respective personalized environments (e.g., the environment 15). As described above, the embedding process is transparent to the users at the client system 11n, and requires no hardware and/or software change to either the web browser of the client system 11n that receive the modified web pages, or the web servers that store the web pages before they are modified to include the context information. This arrangement provides personalized web pages to the users at the client system 11n without having to change the structure of either the web browser at the client system 11n or the remote web servers (e.g., the web server 14). FIG. 2 shows in more detail the structure and the operation of the client system 11n that implements one embodiment of the present invention, which will be described in more detail below.

As can be seen from FIG. 2, the web browser 31 of the client system 11n is operationally connected to the transformation module 32. The transformation module 32 is operationally connected to the context store (or context information store) 33 and the network interface 34. The network interface 34 is used to interface the client system 11n with the external web server 14 (FIG. 1) via the gateway system 12 and the Internet 13 (both shown in FIG. 1). The network interface 34 is a known module and thus will not be described in more detail below.

The web browser 31 is used to receive user input from the user of the client system 11n to generate a user request for a specific web page from the web server 14 (FIG. 1). The web browser 31 then sends the request to the external web server 14 (FIG. 1) via the network interface 34. When the web browser 31 receives a web page, it renders the web page to its user.

The web browser 31 can be implemented by any known web browser (e.g., the Internet Explorer® from Microsoft Corporation of Redmond, Washington or the Netscape® from AOL Time Warner Corporation of New York, N.Y.). The web browser 31 can launch an external application or a plug-in to handle a downloaded file.

The transformation module 32 and the context store 33 implement one embodiment of the present invention. The context store 33 is used to store the context information of all the personalized environments of the client system 11n. This means that the context store 33 stores the context information of the client system 11n. The context store 33 is connected to the transformation module 32.

The transformation module 32 is connected between the web browser 31 and the network interface 34. When the transformation module 32 receives a web page to be sent to the web browser 31, the transformation module 32 accesses the context store 33 for the context information. Once the context information of the client system 11n is retrieved from the context store 33, the transformation module 32 adds URLs or context menus at appropriate locations (e.g., next or adjacent to the content item) within the web page such that the web page becomes modified web page. FIG. 4 shows one such modified web page 50. As can be seen from FIG. 4, the modified web page 40 includes a context menu 51 that includes a number of command-like URLs.

Referring back to FIG. 2, the transformation module 32 embeds the context information using known web page construction means. The transformation module 32 then sends the modified web page to the web browser 31.

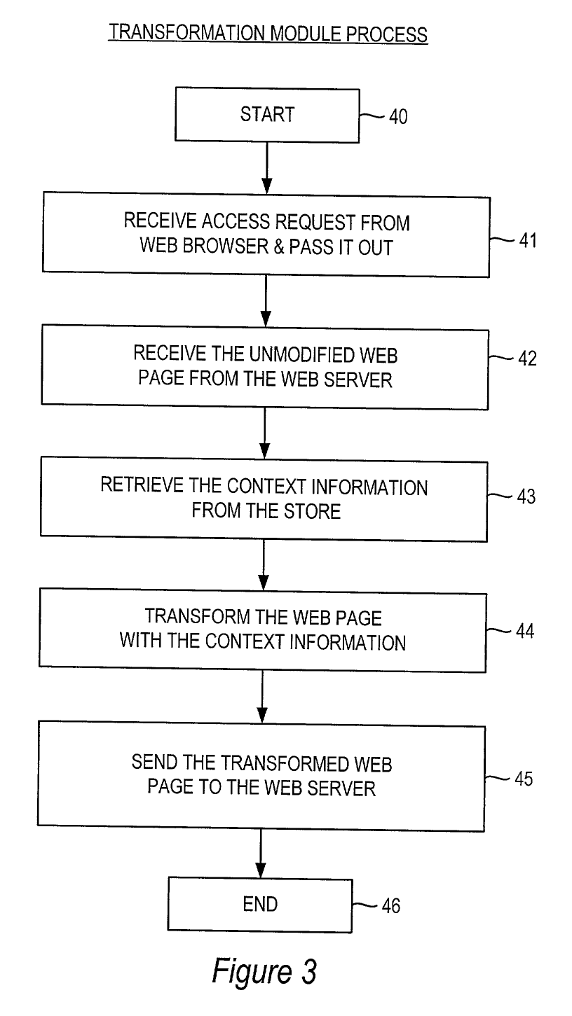

Once the web browser 31 receives the modified web page, it then renders the modified web page to the user of the client system 11n. The user at the client system 11n can click on the embedded URLs in the web page to invoke web-enabled services provided by local or remote Internet-enabled devices. The transformation module 32 is described in more detail below, also in conjunction with FIG. 3.

Referring to FIG. 3, the process of the transformation module 32 of FIG. 2 starts at the step 40. At the step 41, the transformation module 32 receives an access request from the web browser 31 (FIG. 2) and passes it out to the network interface 34 (FIG. 2). At the step 42, the transformation module 32 receives the unmodified web page from the network interface 34 (see FIG. 2).

At the step 43, the transformation module 32 retrieves the context information of the client system 11n (see FIGS. 1-2) from the context store 33 (see FIG. 2). At the step 44, the transformation module 32 transforms or modified the unmodified web page with the context information. This means that the transformation module 32 adds the context information into the unmodified web page. The transformation can be done using any known mechanism.

The modified or transformed web page is then returned to the web browser 31 at the step 45. The process then ends at the step 46.

In the foregoing specification, the invention has been described with reference to specific embodiments thereof. The specification and drawings should, however, be regarded in an illustrative rather than a restrictive sense.

What is claimed is:

1. A context-aware client system, comprising
a web browser that sends a request to a remote web server to retrieve a web page from the remote web server;
a context store that stores context information of the client system;
a transformation module coupled to the web browser and the context store to add the context information into the web page before the web page is rendered by the web browser such that services specified in the context information and available to the client system can be readily invoked via the modified web page.

2. The client system of claim 1, wherein the context information of the client system specifies web-enabled services available to the client system.

3. The client system of claim 2, wherein the context information specifies each of the web-enabled services in the form of a command-like URL (Universal Resource Locator).

4. The client system of claim 2, wherein the transformation module adds the context information into the web page by creating and embedding a context-menu directly in the web page adjacent to a content item, wherein the context-menu includes a list of URL commands specifying a plurality of web-enabled services.

5. The client system of claim 4, wherein each of the URL commands is a location-aware, and URL-dependent command.

6. The client system of claim 1, wherein the context information of the client system specifies web-enabled services offered by physical devices adjacent to the client system.

7. The client system of claim 1, wherein the client system can be stationary or mobile.

8. A method of including context information of a client system into a web page to be rendered on the client system, comprising
storing the context information in a context store;
processing a request to retrieve the web page from a remote web server;
adding the context information into the web page before the modified web page is rendered on the client system such that services specified by the context information and available to the client system can be readily invoked via the modified web page.

8. The method of claim 7, further comprising the step of rendering the modified web page on the client system.

9. The method of claim 7, wherein the context information specifies web-enabled services available to the client system.

10. The method of claim 9, wherein the context information specifies each of the web-enabled services in the form of a command-like URL (Universal Resource Locator).

11. The method of claim 9, wherein the step of adding the context information further comprising
creating a context-menu that includes a list of URL commands specifying a plurality of web-enabled services;
embedding the context-menu directly in the web page adjacent to a content item.

12. The method of claim 11, wherein each of the URL commands is a location-aware, and URL-dependent command.
